(19) United States
(12) Patent Application Publication
(10) Pub. No.: US 2014/0143817 A1
(43) Pub. Date: May 22, 2014

(54) AUDIO/VIDEO BITSTREAM PLAYBACK SYSTEM AND ASSOCIATED METHOD

(71) Applicant: WISTRON CORPORATION, New Taipei City (TW)

(72) Inventor: Yu-Ping Yeh, New Taipei City (TW)

(73) Assignee: Wistron Corporation, New Taipei City (TW)

(21) Appl. No.: 13/847,505

(22) Filed: Mar. 20, 2013

(30) Foreign Application Priority Data
Nov. 22, 2012 (TW) 101143750

(51) Int. Cl. H04N 21/472

(52) U.S. Cl. CPC H04N 21/47202
USPC 725/100

(57) ABSTRACT

An audio/video bitstream playback system and associated method is provided. The playback system includes an audio/video service system, a user device and a playback device signally connected to one another. The playback method includes the following steps. The audio/video service system provides multiple audio/video bitstreams and an operation interface. The user device connects with the audio/video service system, and performs a personalized operation on the multiple audio/video bitstreams via the operation interface. The audio/video service system generates an operation result in response to the personalized operation and stores the operation result. The playback device connects with the audio/video service system, and plays one of the multiple audio/video bitstreams according to the operation result.

This application claims the benefit of Taiwan application Serial No. 101143750, filed Nov. 22, 2012, the subject matter of which is incorporated herein by reference.

### BACKGROUND OF THE INVENTION

1. Field of the Invention

The invention relates in general to a playback system and associated method, and more particularly to an audio/video bitstream playback system and associated method.

2. Description of the Related Art

An alternative playback method providing selections for different users via a network is gradually replacing a conventional playback method of television programs in the recent years. Through the network television, a user is allowed to flexibly select and view a desired program according to personal preferences. Thus, the number of users subscribing video-on-demand (hereinafter, VOD) services continues to grow.

A typical mode of operation of a VOD service provider is as the following. After establishing a network server, audio/video bitstreams are provided via the network server, and a user is allowed to watch television programs by utilizing an electronic product connected to the network. As the user logs in with an authorized account, the VOD service provider provides the user with VOD playback services according to authorized contents.

However, the conventional VOD system contains certain setbacks that compromise viewing experiences of the user.

FIG. 1 shows a schematic diagram of a playback system playing audio/video contents provided by a server. A playback device 13 receives audio/video bitstreams from a server 11 via a network, and a user performs playback control utilizing a remote control device 15. The playback device 13 commonly refers to an electronic device capable of playing audio/video bitstreams, e.g., a digital television, or a set-top box employed by a conventional television.

The remote control device 15 serves as a control medium while the user views a VOD program on the playback device 13. Such operation approach is yet rather sophisticated as a VOD system service offers numerous selection functions.

FIG. 2A shows a schematic diagram of a display image 131 providing a video search function when the playback device 13 is connected to a server. Since the server provides a colossal amount of videos, an associated operation interface is first displayed on the display image 131 for the user to select a particular video or program to be viewed.

For example, the display image 131 provides a query column for inputting a keyword or a search string. Alternatively, the user may also enter a search string if the user is unsure of the exact name of a desired movie. The display image 131 further provides a screen keyboard for the user to enter string contents.

Further, as the user enters the string, the user selects buttons on the screen keyboard by controlling movements of a cursor utilizing the remote control device 15. However, the input method of the remote control device 15 is less convenient and handy compared to a mouse or a keyboard. Consequently, an increased amount time is required for entering the query string.

FIG. 2B shows a schematic diagram of a common remote control device for controlling a set-top box or a digital television. A common remote control device is equipped with a limited number of buttons since it is not sizable in volume. In contrast, as the number of buttons on the remote control device 15 gets larger, the arrangement on the remote control device 15 may become too crowded to make selection operations performed by the user uneasy. Therefore, to enter a string by the remote control device 15 cooperating with the display image is inconvenient.

In certain prior art, a mouse or a keyboard is additional provided. That is, an external input device is provided to cooperate with a digital television. Such operation approach causes issues of increased equipment and installation costs as well as extra space.

Apart from viewing programs on a television with a set-top box, a VOD service provider also offers a user with an option of viewing. Therefore, the user may subscribe or select television programs on a laptop computer or a portable pad connected to a server of the VOD service provider.

A personal computer or a portable pad supports the Internet function, and is thus capable of downloading and playing audio/video streams. Further, a personal computer or a portable pad can be operated through a mouse, a keyboard or touch control, and is more readily operable with respect to the operation interface provided by the VOD service provider.

Nevertheless, display range of a computer or a portable pad is much smaller than a conventional television. In the event that the user wishes to view program contents on a large screen, or multiple user wish to view program contents together, the playback method of using a computer or a portable pad is also quite inconvenient.

That is to say, the conventional VOD system is faced with a dilemma. More specifically, based on convenience considerations of searching and selection operations, a user device (e.g., a personal computer, a portable pad or a handheld set) is more ideal for operating function options of a VOD system. However, from a viewing convenience perspective, a large-screen television allows a user to view a video provided by the VOD system with better ease.

Therefore, there is a need for a solution that offers a user with more convenient operations while also allowing a user to view a television program on a large screen.

### SUMMARY OF THE INVENTION

According to an aspect of the present invention, an audio/video bitstream playback system is provided. The audio/video bitstream playback system includes: an audio/video service system, providing a plurality of audio/video bitstreams and an operation interface; a user device, signally connected to the audio/video service system, for performing a personalized operation on the audio/video bitstreams via the operation interface, such that the audio/video service system generates and stores an operation result in response to the personalized operation; and a playback device, signally connected to the audio/video service system, for receiving one of the plurality of audio/video bitstreams according to the operation result.

According to another aspect of the present invention, a playback method for an audio/video service system, a user device and a playback device signally connected to one another is provided. The playback method includes steps of: the audio/video service system providing a plurality of audio/video bitstreams and an operation interface; the user device connecting with the audio/video service system; the user device performing a personalized operation on the audio/video bitstreams via the operation interface; the audio/video service system generating and storing an operation result in response to the personalized operation; the playback device connecting with the audio/video service system; and the playback device receiving one of the plurality of audio/video bitstreams according to the operation result.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 (prior art) is a schematic diagram of a server providing audio/video contents and a playback device for viewing the audio/video contents;

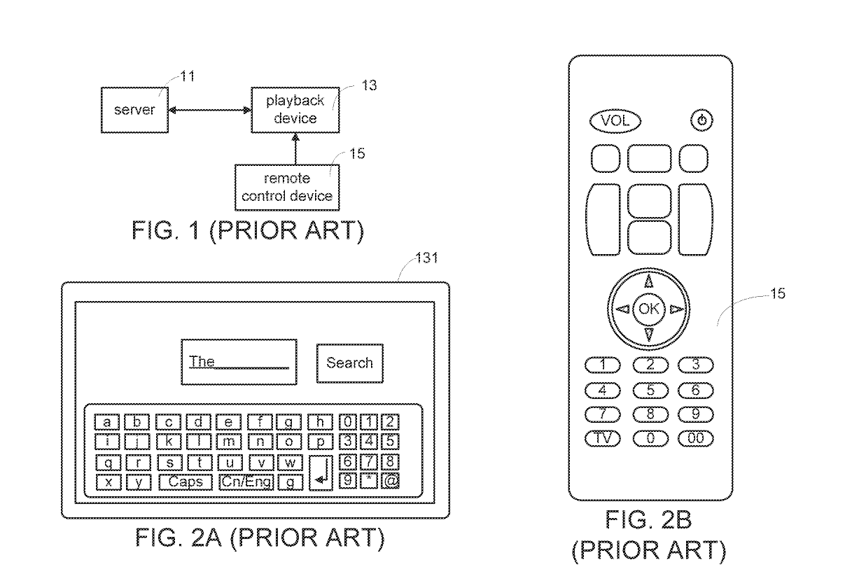

FIG. 2A (prior art) is a schematic diagram of a display image providing a search function when a playback device is connected to a server;

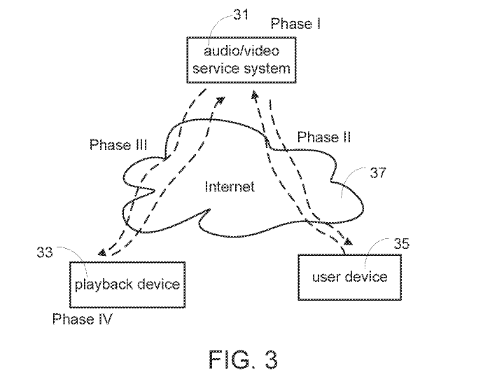

FIG. 2B (prior art) is a schematic diagram of a common remote control device for controlling a set-top box or a digital television;

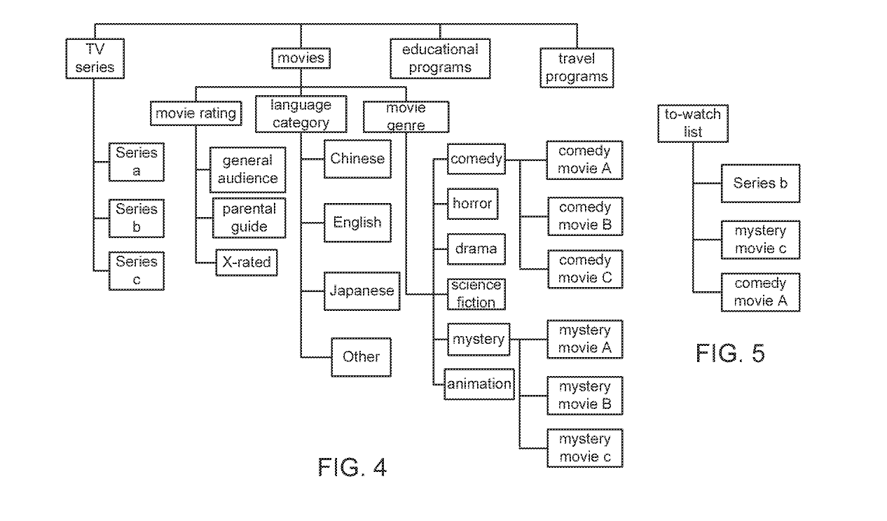

FIG. 3 is a schematic diagram of an audio/video bitstream playback system according to an embodiment of the present invention;

FIG. 4 is a schematic diagram of a function list of service options provided by an audio/video service system;

FIG. 5 is a schematic diagram of editing a function menu of an audio/video service system via a user device;

FIGS. 6A and 6B are a flowchart of an application process of an audio/video service system according to an embodiment of the present invention;

FIG. 7 is a block diagram of an audio/video bitstream playback system according to an embodiment of the present invention;

FIGS. 8A and 8B are schematic diagrams of an audio/video bitstream playback method applied to an audio/video bitstream playback system according to an embodiment of the present invention; and,

FIGS. 9A and 9B are a flowchart of a playback method applied to an audio/video service system, a user device and a playback device according to an embodiment of the present invention.

### DETAILED DESCRIPTION OF THE INVENTION

As previously described, a conventional VOD system suffers from certain setbacks that compromise viewing conveniences of a user. Therefore, an audio/video bitstream playback system and associated method is provided by the present invention for enhancing operation convenience of the VOD system.

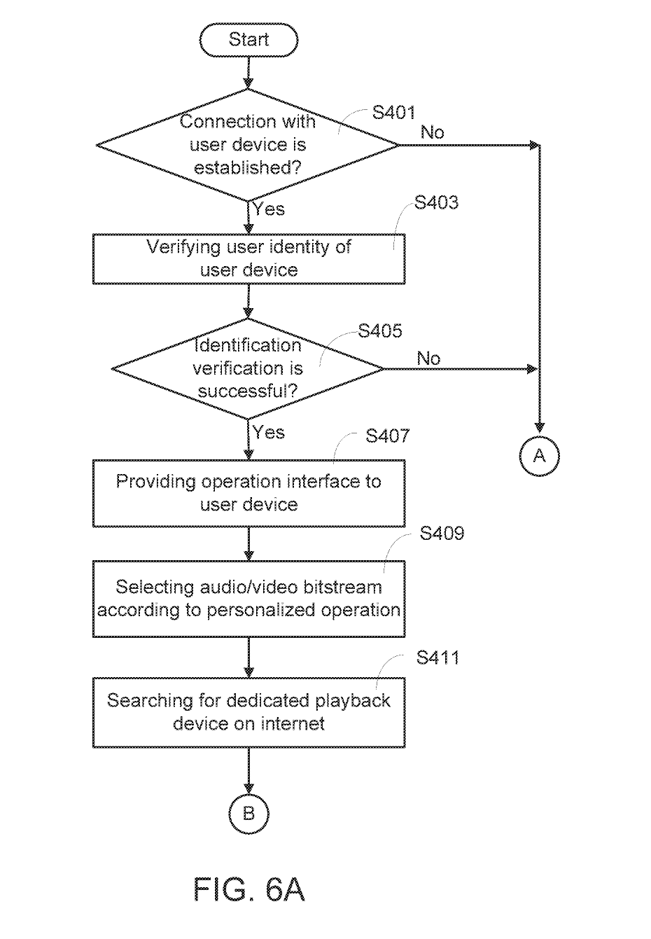

FIG. 3 shows a schematic diagram of an audio/video bitstream playback system according to an embodiment of the present invention. The audio/video bitstream playback system includes an audio/video service system 31, a user device 35 and a playback device 33. The audio/video service system 31, the user device 35 and the playback device 33 are connected to one another via the internet 37.

According to a concept of the present invention, a process that the audio/video service system 31 provides audio/video bitstreams is substantially divided into four following stages—a first stage I performed solely by the audio/video service system 31, a second stage II performed between the user device 35 and the audio/video service system 31, a third stage III performed between the audio/video service system 31 and the playback device 33, and a fourth stage IV performed by the playback device 33.

Interactions and operations of these phases among the devices are to be described in detail shortly.

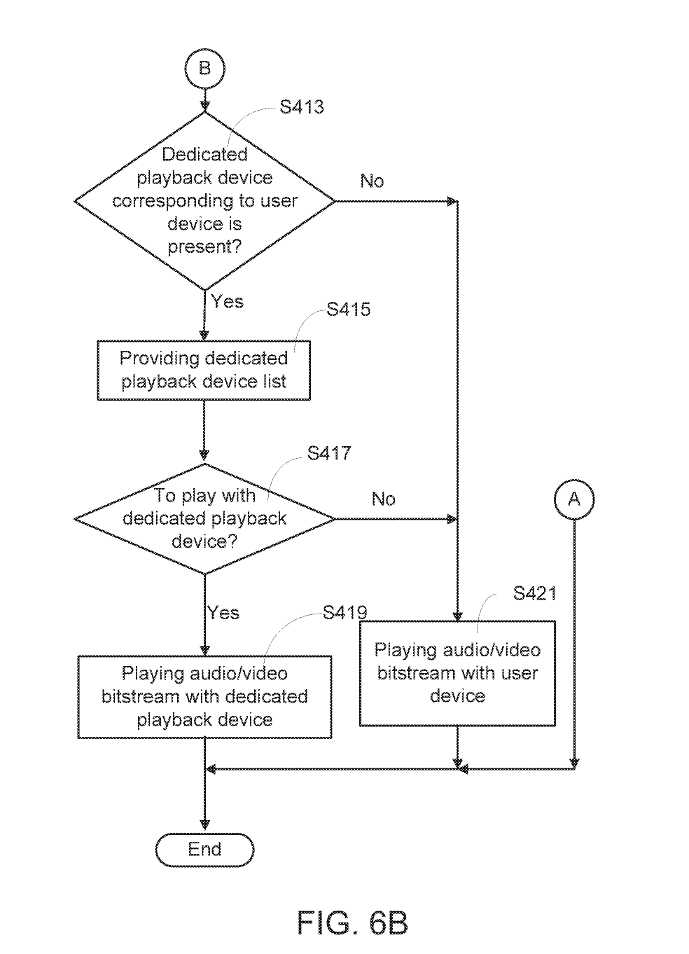

FIG. 4 shows a schematic diagram of a function list of service operations provided by an audio/video service system. For clear illustrations, function operations provided by the audio/video service system are omitted.

As shown in FIG. 4, although the diversified function options offer a user with a large number of selections, a directory architecture in the diagram appears too sophisticated for operations utilizing a remote control device. Therefore, when a user wishes to find a specific option, such directory architecture may be quite disturbing.

For example, assume that the audio/video service system 31 provides four types of programs including television series, movies, educational programs and travel programs. The television series program type provides three series including series a, series b and series c.

On the other hand, the movie type programs provide the user to select according to movie ratings, language categories and movie genres. Further, each of the movie genres including comedy, horror, drama, science fiction, mystery and animation contains different movies for the user to select from.

Assume that the comedy movie genre includes a comedy movie A, a comedy movie B and a comedy movie C. And, the mystery movie genre includes a mystery movie A, a mystery movie B and a mystery movie C.

When program contents that a user wishes to view are the television series b, the mystery movie C and the comedy movie A, the user needs to first enter the series directory menu to select the television series b to a to-watch list. The user then sequentially selects movies->movie genre->comedy, and selects the comedy movie A to the to-watch list. Moreover, the user needs to again select the tree-directory of movies->movie genre->mystery in order to select the mystery movie C to the to-watch list.

Therefore, when the user wishes to view several programs or videos of different types, with the conventional audio/video bitstream playback system, the user is compelled to repeatedly use up and down buttons of a remote control device in order to switch among upper-hierarchy and lower-hierarchy menus.

In contrast, according to a concept of the present invention, the foregoing selection process can be performed on a user device. As a user device is equipped with an input device such as a mouse or a keyboard, the selection process on the user device can be more readily performed.

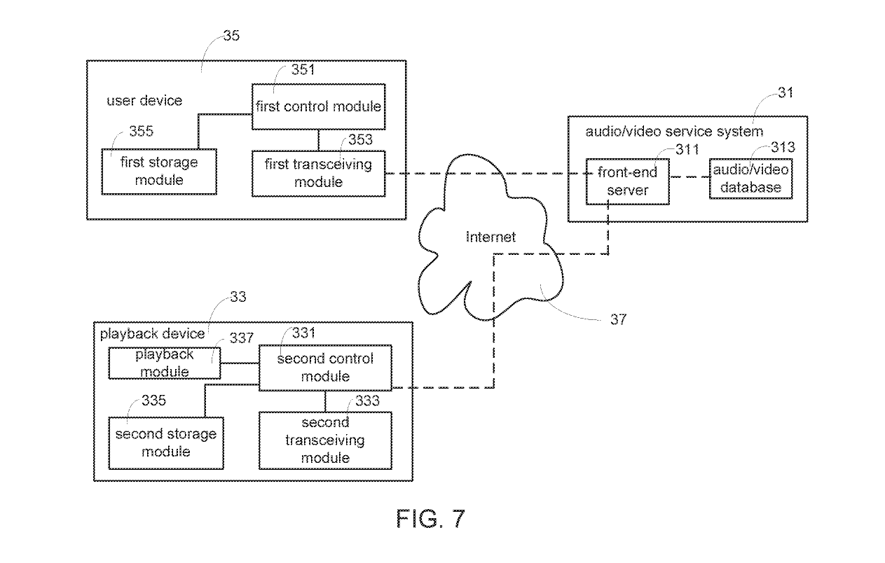

FIG. 5 shows a schematic diagram of a user device allowing a user to edit a function menu according to personal preferences. In FIG. 5, it is assumed that the user performs query, searching and selection operations via the user device on the basis of the function menu in FIG. 4 to generate a personalized to-watch list. For example, the user first selects the television series b, the mystery movie c and the comedy movie A using a computer, and stores the selected video/audit bitstreams to the to-watch list.

Thus, when the playback device 33 connects to the audio/video service system 31, the user is not required to utilize the playback device 33 to select desired contents from the data architecture in FIG. 4. In fact, when the playback device 33 connects to the audio/video service system 31, a display image can be configured to display only the to-watch list. At this point, the display image on the playback device 33 displays only the television series b, the mystery movie C and the comedy movie A, as shown in FIG. 5. As such, the user is allowed to easily select which of the audio/video bitstreams is to be first watch through buttons (up ↑ and down ↓ buttons) on the remote control device.

As such, although the user selects the contents of the audio/video bitstreams also using the directory architecture in FIG. 4, the selection process is nevertheless performed utilizing the user device 35. For example, the user device 35 is a laptop computer, a portable pad or a smart mobile handset, which has a more friendly operation interface. Further, the user device may coordinate with a more handy input method using a mouse, a keyboard or a touch pad to search and edit audio/video bitstreams.

Further, assume that the user wishes to find a particular desired movie, and searches for the movie under the science fiction genre. It is possible that a service provider of the audio/video service system 31 categorizes the particular desired movie to the horror genre. As a result, the user may fail to find the particular desired movie after sequentially searching through the entire directory on the science fiction genre by manipulating on the remote control device.

At this point, assume that the service provider of the audio/video service system 31 provides a keyword query function through the operation interface. For example, the user enters “animal” as a query string. The audio/video service system then searches for videos and movies in a name containing the searched string on the basis of the keyword “animal”.

Similarly, the search process for the keyword can also be accelerated through the user device 35.

Assume that the audio/video service system 31 offers 10,000 movies in total, and ten movies are found as search results according to the search string. The user may then quickly browse plot summaries of the ten movies through the user device 35, and select a part or all of the ten movies to the to-watch list. That is, for audio/video bitstreams of each program, the audio/video service system 31 may also provided associated auxiliary information. With the provision of the auxiliary information, the user is allowed to judge whether the program matches personal preferences.

Apart from the search string, when the user sets the search condition utilizing the user device 35, associated search parameters may also be additionally set. For example, the user may set to search through programs of a particular language category, or search through movies and programs within the past one year.

When operating the operation interface, different users may generate personalized operation instructions (e.g., setting the search condition) according to personal requirements. These personalized operation instructions are transmitted to the audio/video service system 31. The audio/video service system 31 then generates operation results corresponding to the personalized operations.

As the present invention does not need the playback device 33 to display a screen keyboard for cooperating with a remote control device for entering a search string, the search process for the string can be easily achieved. Even if the user enters an erroneous keyword such that the search process is repeatedly performed, the overall search process can still performed in a quite simple manner.

In other words, according to an embodiment of the present invention, by using the user device 35 such as a computer or a portable pad, the user can easily search for a desired audio/video bitstream through the operation interface provided by the audio/video service system 31.

Similarly, the user can further find one or multiple videos (selected audio/video bitstreams) according to the personalized operation result obtained from searching, and set the searched video program(s) to the to-watch list.

Thus, when a playback system adopts the approach of the present invention, the audio/video service system can place user-preferred program contents to a same directory (the to-watch list) according to editing of the user.

In other words, the audio/video service system 31 of the present invention is capable of transmitting audio/video bitstreams corresponding to search, editing and selection results according to the operation results of personalized operations to a television (also referred to a dedicated playback device) corresponding to a user account. Therefore, the user is able to play the audio/video bitstreams via the television using a simple and convenient approach.

According to a concept of the present invention, after the user performs personalized selection and search operations on the audio/video bitstreams utilizing the user device 35, the audio/video service system 31 stores the operation result. The playback device 33 then plays the audio/video bitstreams corresponding to the operation result, thereby enhancing operation conveniences.

It should be noted that, an example of playing a movie is given for explaining the present invention. However, types of audio/video services provided by the service provider may be quite diversified. Further, the source and generation means of the audio/video bitstreams are not limited.

For example, the audio/video bitstreams may be commercial movies provided by an audio/video service provider (e.g., AT&T or another VOD service provider), computer games provided by game service providers, or user-captured audio/video bitstreams transmitted to the audio/video service system via the user device.

Further, the operation interface provided by the audio/video service provider is not limited to support only query on an audio/video database. For example, assume that the user wishes to edit contents of the audio/video bitstreams. From contents of multiple original audio/video bitstreams, the user may utilize the user device to retrieve, fetch, modify or edit program clips to be viewed through the operation interface. After that, the playback device is used for playing an audio/video bitstream collected from the retrieved program clips.

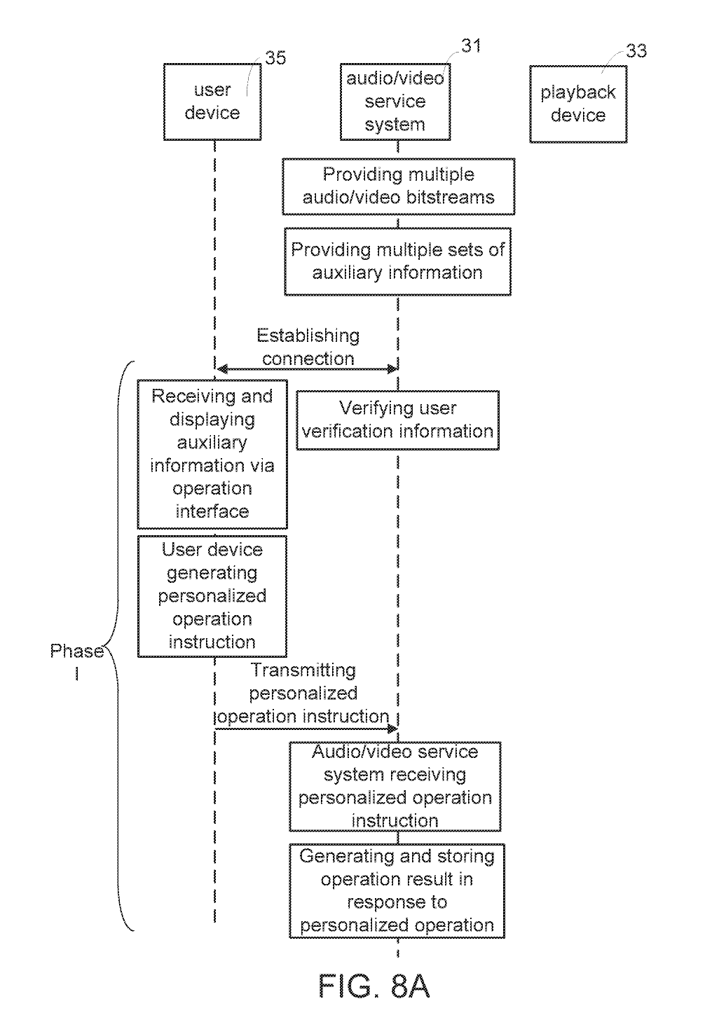

FIGS. 6A and 6B are flowchart of an application process of an audio/video service system according to an embodiment of the present invention.

In step S401, a service provider of the audio/video service system 31 determines whether a connection is established with a user device. The process ends if the connection is not established, or else step S403 is performed to verify an identity and a user permission of the user device.

In step S405, it is determined whether the identification verification is successful. The process ends when the identification verification is not successful, or else step S407 is performed. In step S407, the audio/video service system 31 allows the user to perform a search operation and a function such as category search on audio/video bitstreams (i.e., a personalized operation) via the operation interface. In step S409, the audio/video service system 31 obtains a selected audio/video bitstream selected according to the personalized operation of the user.

Different service agreements may be defined between the service provider of the audio/video service system 31 and different users. Depending on contents of the service agreements, a personalized operation interface may also be provided according to the identity of the user during the identification verification of the user account.

Assume that a user A specifies which playback devices are to serve as dedicated playback devices for actual playback when the user A signs a service agreement with the audio/video service provider.

For example, the user A may have three televisions in the household, respectively located at a master bedroom, a living room and a child's room. However, the user A does not want the child to watch Internet television whenever as the child pleases. Thus, the user A may choose the television in the living room and the television in the master bedroom as the dedicated playback devices.

Hence, when the user A wishes to view television programs, the desired television programs can be played using the television (first playback device) in the living room, or the television (second playback device) in the master bedroom in the household.

Therefore, as the user A completes a searching or selection operation after connecting the user device 35 to the audio/video service system 31, the audio/video service system 31 first searches for a dedicated playback device having an access permission to the audio/video database, as shown in step S411.

In this embodiment, a playback device 33 with the special access permission may be regarded as the dedicated playback device corresponding to the user account. According to a concept of the present invention, only a dedicated playback device system with a successful access permission can be approved/verified by the audio/video service system, and then be further utilized to play the user-selected audio/video bitstream.

In step S413, the audio/video service system 31 determines whether these dedicated playback devices correspond to the user device 35. The purpose of this step is to confirm which of the dedicated playback devices is signally connected to the Internet 37 corresponding to the user device 35.

For example, if the service agreement specifies that the user is allowed to choose two playback devices for playing audio/video bitstreams. The two playback device should correspond to the user account. Further, the audio/video service system 31 needs to first confirm the playback device (dedicated playback device) with the special access permission in order to play the audio/video bitstream selected by the user.

Assume that ten playback devices signally connected to the audio/video service system 31 are available on the Internet. However, it is possible that only one among the ten playback devices corresponds to the user account, while the remaining nine playback devices may correspond to other users' accounts.

At this point, it means that one between the two dedicated playback devices corresponding to the account of the user A is powered off or offline, meaning that only one dedicated playback device corresponding to the account of the user A is connected to the Internet 37. Thus, the number of dedicated playback devices that can actually be chosen is determined according to the service agreement of both parties as well as an actual connection status of the dedicated playback devices.

When a determination result of step S413 is negative, it means that the selection of the user A cannot be successfully set. That is, not both of the dedicated playback devices corresponding to the account of the user A are signally connected to the Internet. In step S421, the audio/video service system 31 transmits the audio/video bitstream to the user device 35 instead, which then plays the audio/video bitstream.

In contrast, when the determination result of step S413 is affirmative, the user can choose which of the dedicated playback devices is to be utilized for playing the selected audio/video bitstream according to a dedicated playback device list provided by the audio/video service system 31.

In continuation of the foregoing example, the dedicated playback device list presented on the operation interface includes options of the first playback device and the second playback device. In step S417, the user determines whether to play the audio/video bitstream using the dedicated playback device. If a determination result is negative, step S421 is performed. In step S421, the user chooses the user device 35 to play the audio/video bitstream if the user does not wish to play the audio/video bitstream using the dedicated playback device.

In contrast, the audio/video service system 31 transmits the audio/video bitstream to the dedicated playback device chosen by the user. The audio/video bitstream being transmitted is corresponding to a user selection result. In step S419, the chosen dedicated playback device plays the audio/video bitstream.

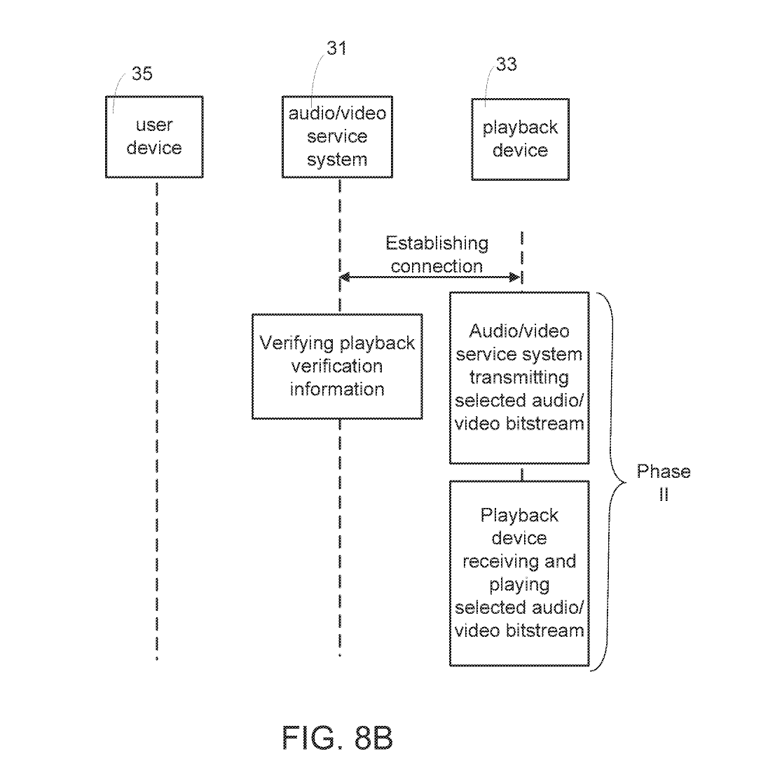

FIG. 7 shows a block diagram of an audio/video bitstream playback system according to an embodiment of the present invention. The audio/video bitstream playback system according to an embodiment includes an audio/video service system 31, a user device 35 and a playback device 33. The playback device 33 represents a dedicated playback device that corresponds to a user account and has an access permission.

The audio/video service system 31 is signally connected to the user device 35 and the playback device 33 via the Internet 37. The Internet may be various types of networks such as an ADSL network, an optical fiber network, a wireless network, and a coaxial cable etc.

The audio/video service system 31 includes an audio/video database 313 and a front-end server 311. The audio/video service system 31 may further include a management server and a search engine.

Audio/video bitstreams stored in the audio/video database 313 may be provided by an audio/video bitstream service provider or a game service provider, or uploaded/transmitted by the user to the audio/video service system 31 via the user device 35r. Further, the audio/video database 313 also stores auxiliary information associated with each of the audio/video bitstreams, so that the user device 35 may receive the auxiliary information via the operation interface.

With the auxiliary information cooperating with the audio/video bitstreams, the user is able to more accurately comprehend substantial contents of the audio/video bitstreams. For example, the auxiliary information may be texts describing a provider, a generation time, content introduction, a preview, a plot summary, cast and a theme of the audio/video bitstreams.

The front-end server 311, signally connected to the audio/video database 313, provides an operation interface and stores an operation result generated according to a personalized operation. The operation interface may display the auxiliary information associated with the audio/video bitstreams, and provide functions of searching, selection, editing and playback operations for the audio/video bitstreams.

The front-end server 311 first verifies the account list and confirms the transmissions and the playback methods of the user device 35 and the playback device 33, so as to ensure that agreed type between the user device 35 and the service provider is fulfilled. The user device 35 has user verification information corresponding to the user account, and the playback device 33 similarly has playback verification information corresponding to the user account.

When the front-end server 311 is signally connected to the user device 35, the front-end server 311 verifies the user verification information corresponding to the user account. When the front-server 311 is signally connected to the playback device 33, the front-end server 311 verifies the playback verification information corresponding to the user account.

A same user account corresponds to at least one user device 35 and one playback device 35. However, relations among the user account, the user device 35 and the playback device 33 are not limited to one-on-one relations.

For example, in the service agreement, the user may also specify the number of the user device 35 and the number of the playback device 33 corresponding to his/her user account. Thus, different user accounts may correspond to one same user device 35 and/or one same playback device 33. Alternatively, one user account may correspond to multiple user devices 35 and/or multiple playback devices 33.

Details of account management, and corresponding relations among the user account, the user device 35 and the playback device 33 can be implemented by a person having ordinary skill in the art as desired, and shall be omitted herein.

The user device 35 commonly refers to an electronic device that can be signally connect to the Internet 37, and supports Internet protocols and applications. The user device 35 performs a personalized operation on the audio/video bitstreams, so that the audio/video service system 31 generates and stores personalized operation results in response to users' personalized operations.

The user device 35 includes a first control module 351, a first transceiving module 353 and a first storage module 355. The first control module 351 is electrically connected to the first transceiving module 353 and the first storage module 355. The first transceiving module 353 is signally connected to the Internet, and transceives the user verification information as well as the control information associated with query, searching and editing operations according to control of the first control module 351.

The playback device 33 includes a second control module 331, a second transceiving module 333, a second storage module 335, and a playback module 337. The second control module 331 is electrically connected to the other three modules. The second transceiving module 333 is signally connected to the Internet, and transmits the playback verification information and receives audio/video bitstreams according to control of the second control module 331. The playback module 337 may include a display device for playing audio/video bitstreams, and/or a speaker for playing audio bitstreams.

In practice, the second storage module 335 may be implemented by a non-volatile storage device (e.g., a flash memory) and/or a volatile storage device.

When implementing a non-volatile memory storage device for storing audio/video bitstreams, the playback device 33 is capable of playing previously downloaded audio/video bitstreams in a next power-on.

When implementing a volatile memory storage, audio/video bitstreams are temporarily stored. At this point, the audio/video bitstreams are in realtime played by the playback module 337 under control of the second control module 331.

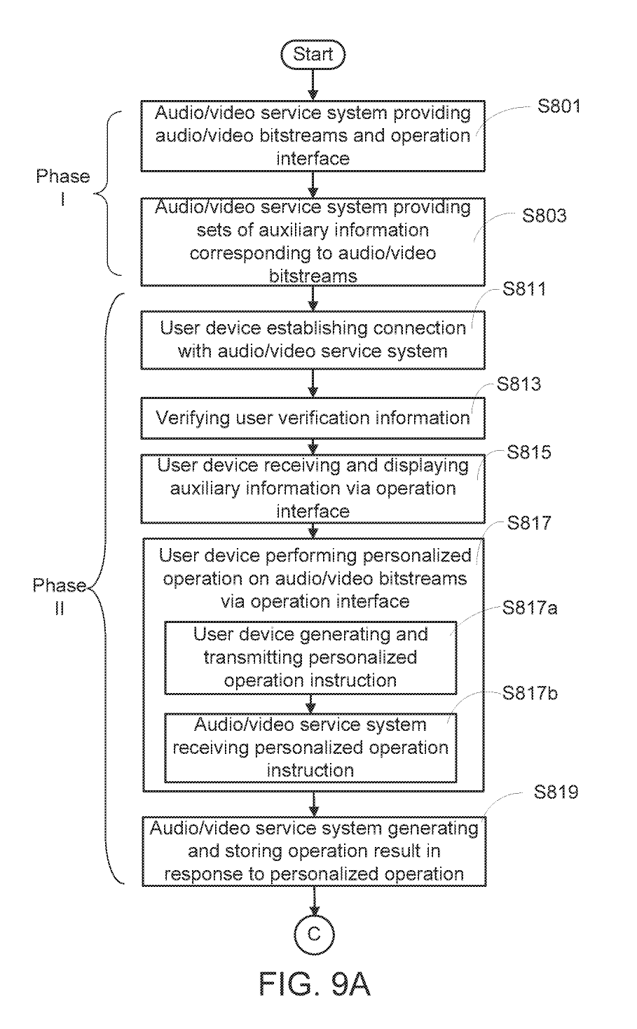

Operations and interactions of the devices in the playback system are to be described with reference to FIG. 8.

FIGS. 8A and 8B represent schematic diagrams of an audio/video bitstream playback method performed by an audio/video bitstream playback system according to an embodiment of the present invention. The user device 35 corresponds to user verification information, and the playback device 33 corresponds to playback verification information.

In FIGS. 8A and 8B, a time order is indicated in an up-down direction, and behaviors of the user device 35, the audio/video service system 31 and the playback device 33 are represented from left to right. Further, operations independently performed by the devices are represented in blocks, and arrows represent transmissions and receptions among different devices.

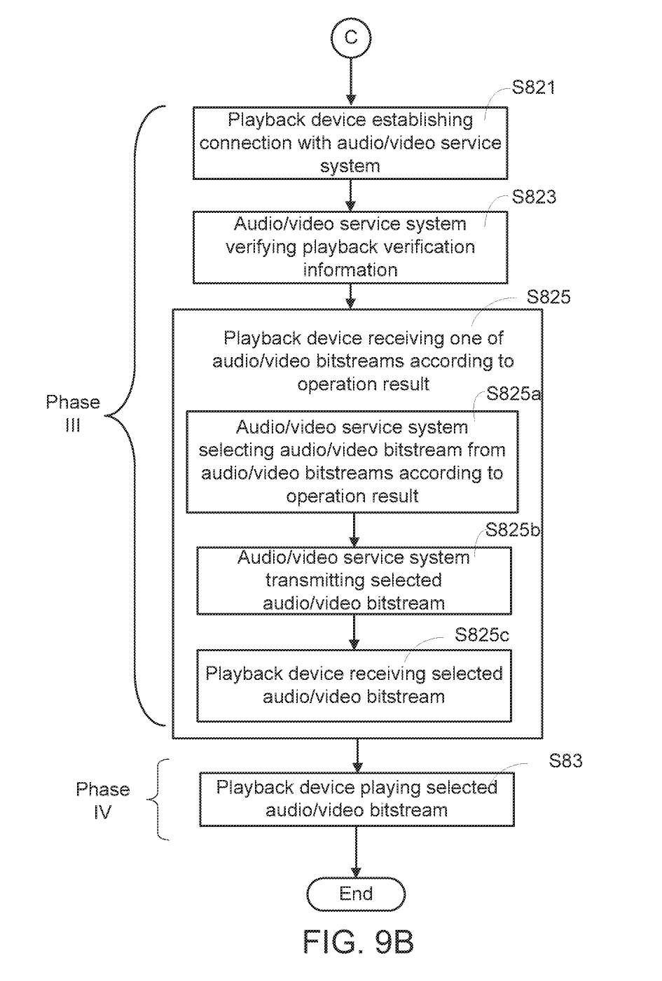

Descriptions on FIG. 8 are to be given also with reference to a flowchart shown in FIGS. 9A and 9B.

FIGS. 9A and 9B are a flowchart of a transmission process of control information and audio/video bitstreams among the user device, the audio/video service system and the playback device in an audio/video bitstream playback system according to an embodiment of the present invention.

In a first stage I, the audio/video service system 31 provides a plurality of audio/video bitstreams and an operation interface in step S801, and further provides a plurality of sets of auxiliary information corresponding to the plurality of audio/video bitstreams in step S803.

Interactive operations among the devices can be divided into two stages—a second stage II performed between the user device 35 and the audio/video service system 31, and a third stage III performed between the playback device 33 and the audio/video service system 31.

In the second stage II, the user device 35 establishes a connection with the audio/video service system 31 in step S811; the audio/video service system 31 verifies the user verification information in step S813; the user device 35 receives and displays the auxiliary information via the operation interface in step S815; the user device 35 performs a personalized operation on the audio/video bitstreams via the operation interface in step S817; and the audio/video service system 31 generates and stores an operation result in response to the personalized operation of the user in step S819.

In step S817, the personalized operation refers to searching, selection, editing and playback operations on the audio/video bitstreams according to the auxiliary information corresponding to the audio/video bitstreams. Step S817 includes the following steps. The user device 35 generates and transmits a personalized operation instruction in step S817a; and the audio/video service system 31 receives the personalized operation instruction in step S817b.

In step S819, the operation result refers to, among the audio/video bitstreams, an audio/video bitstream satisfying the personalized operation instruction.

In the third stage III, the playback device 33 establishes a connection with the audio/video service system 31 in step S821; and the audio/video service system 31 verifies the playback verification information of the playback device 33 in step S823.

It is assumed that both of the playback verification information and the user verification information match the same user account. Thus, the playback device 33 has an access permission, and plays one of the audio/video bitstreams according to the operation result in step S825.

Step S825 includes the following steps. The audio/video service system 31 selects a selected audio/video bitstream from the audio/video bitstreams according to the operation result in step S825a; the audio/video service system 31 transmits the selected audio/video bitstream in step S825b; and the playback device 33 receives the selected audio/video bitstream in step S825c.

When the selected audio/video bitstream is received by the playback device 33, the fourth stage IV is performed by the playback device 33.

In the fourth stage IV, the playback device 33 plays the selected audio/video bitstream in step S83. The playback device 33 may start playing the selected audio/video bitstream while still receiving the selected audio/video bitstream. Alternatively, the playback device 33 may start playing contents of the selected audio/video bitstream after the selected audio/video bitstream is completely received.

In a further application, interactive operations among the audio/video service system 31, the user device 35 and the playback device 33 may be designed according to personal requirements, or flexibly adjusted according to the service agreement provided by the service provider of the audio/video service system 31.

For example, assume that a service contract is established between the service provider of the audio/video service system 31 and the user A. The service contract may further specify the number of the playback devices 33 allowed for the user A, and actual locations of the playback devices.

Assume that the agreement between the service provider of the audio/video service system 31 and the user A allows the user A with only a predetermined playback device 33 (dedicated playback device). If the user A agrees to utilize only a television in the household as the playback device 33 in the contract, the audio/video service system 33 is required to confirm that the playback device 33 is in the household of the user A before permitting the user to download audio/video bitstreams.

Alternatively, assume that the agreement allows the user A to operate with different playback devices 33 for playing audio/video bitstreams. At this point, the user A may first select a movie on the audio/video service system 31 utilizing a laptop computer at home. The user A then downloads the selected movie with a television at a friend's home where the user attends a gathering, and views the downloaded movie with friends.

According to actual contents of the service agreement, details of the identification verification process and access permission among the audio/video service system 31, the user device 35 and the playback device 33 may also be adjusted according to actual requirements.

Therefore, the operation interface provided to the user device by the audio/video service system offers diversified service contents. The service contents from editing, selection or searching operations can be easily performed and completed via various types of input devices (e.g., a mouse, a keyboard or a touch control input device), thereby significantly improving complications of controlling the playback device utilizing a remote control device.

In conclusion, in the present invention, more sophisticated operations are performed by the user device in advance, and the subsequent playback operation is then performed by the playback device. Such approach satisfies both operation and playback conveniences as well as mitigating setbacks of the prior art.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An audio/video bitstream playback system, comprising:
an audio/video service system, for providing a plurality of audio/video bitstreams and an operation interface;
a user device, signally connected to the audio/video service system, for performing a personalized operation on the plurality of audio/video bitstreams via the operation interface, such that the audio/video service system generates and stores an operation result; and
a playback device, signally connected to the audio/video service system, for receiving one of the plurality of audio/video bitstreams according to the operation result.

2. The playback system according to claim 1, wherein the audio/video service system further comprises:
an audio/video database, for storing the plurality of audio/video bitstreams; and
a front-end server, signally connected to the audio/video database, for providing the operation interface and storing the operation result.

3. The playback system according to claim 1, wherein the user device generates and transmits a personalized operation instruction to the audio/video service system, and the operation result is an audio/video bitstream among the plurality of audio/video bitstreams, satisfying the personalized operation instruction.

4. The playback system according to claim 1, wherein the user device corresponds to user verification information, and the playback device corresponds to playback verification information.

5. The playback system according to claim 4, wherein the audio/video service system verifies the user verification information when connecting with the user device, and verifies the playback verification information when connecting with the playback device.

6. The playback system according to claim 1, wherein
the audio/video service system selects a selected audio/video bitstream from the plurality of audio/video bitstream according to the operation result;
the audio/video service system transmits the selected audio/video bitstream; and
the playback device receives the selected audio/video bitstream.

7. The playback system according to claim 1, wherein the audio/video service system provides a plurality of sets of auxiliary information corresponding to the plurality of audio/video bitstreams, and the user device receives and displays the plurality of auxiliary information via the operation interface.

8. The playback system according to claim 7, wherein the personalized operation is a search operation, a selection operation, an editing operation or a playback operation on the plurality of audio/video bitstreams according to the auxiliary information.

9. The playback system according to claim 1, wherein the plurality of audio/video bitstreams are provided by an audio/video service provider, provided by a game service provider, or transmitted to the audio/video service system via the user device by a user.

10. A playback method, for an audio/video service system, a user device and a playback device signally connected to one another, the playback method comprising steps of:
the audio/video service system providing a plurality of audio/video bitstreams and an operation interface;
the user device establishing a connection with the audio/video service system;
the user device performing a personalized operation on the plurality of audio/video bitstreams via the operation interface;
the audio/video service system generating and storing an operation result in response to the personalized operation;
the playback device establishing a connection with the audio/video service system; and
the playback device receiving one of the plurality of audio/video bitstreams according to the operation result.

11. The playback method according to claim 10, wherein the step of the user device performing the personalized operation on the plurality of audio/video bitstreams via the operation interface comprises steps of:
the user device generating and transmitting a personalized operation instruction; and
the audio/video service system receiving the personalized operation instruction.

12. The playback method according to claim 11, wherein the operation result is an audio/video bitstream among the plurality of audio/video bitstreams, satisfying the personalized operation instruction.

13. The playback method according to claim 12, wherein the user device corresponds to user verification information, and the playback device corresponds to playback verification information.

14. The playback method according to claim 13, further comprising steps of:
the audio/video service system verifying the user verification information when connecting with the user device; and
the audio/video service system verifying the playback verification information when connecting with the playback device.

15. The playback method according to claim 10, wherein the step of the playback device receiving one of the plurality of audio/video bitstreams according to the operation result comprises steps of:
the audio/video service system selecting a selected bitstream from the plurality of audio/video bitstreams according to the operation result;
the audio/video service system transmitting the selected audio/video bitstream; and
the playback device receiving the selected audio/video bitstream.

16. The playback method according to claim 10, further comprising steps of:
the audio/video service system providing a plurality of sets of auxiliary information corresponding to the plurality of audio/video bitstreams; and
the user device receiving and displaying the plurality of auxiliary information via the operation interface.

17. The playback method according to claim 16, wherein the personalized operation is a search operation, a selection operation, an editing operation or a playback operation on the plurality of audio/video bitstreams according to the plurality of auxiliary information.

18. The playback method according to claim 10, wherein the plurality of audio/video bitstreams are provided by an audio/video service provider, provided by a game service provider, or transmitted to the audio/video service system via the user device by a user.
